(19) United States
(12) Patent Application Publication
(10) Pub. No.: US 2023/0135990 A1
(43) Pub. Date: May 4, 2023

(54) ANTENNA DEVICE

(71) Applicant: KABUSHIKI KAISHA TOKAI RIKA DENKI SEISAKUSHO, Aichi (JP)

(72) Inventors: Koji INAFUNE, Aichi (JP); Kenichi KOGA, Aichi (JP); Tatsuya KOIKE, Aichi (JP); Satoshi MORI, Aichi (JP)

(73) Assignee: KABUSHIKI KAISHA TOKAI RIKA DENKI SEISAKUSHO, Aichi (JP)

(21) Appl. No.: 17/961,886

(22) Filed: Oct. 7, 2022

(30) Foreign Application Priority Data
Oct. 29, 2021 (JP) 2021-177857

(51) Int. Cl. H01Q 9/04; H01Q 1/38

(52) U.S. Cl. CPC H01Q 9/045; H01Q 1/38

(57) ABSTRACT

there is provided an antenna device comprising a flat dielectric substrate a radiating element disposed on a surface of the dielectric substrate and a ground plane disposed on another surface opposite to the surface of the dielectric substrate wherein the radiating element has a size corresponding to operating frequency of the radiating element, and the ground plane has a plurality of openings that are periodically made at a pitch less than ¼ wavelength of the operating frequency.

### CROSS REFERENCE TO RELATED APPLICATION(S)

This application is based upon and claims benefit of priority from Japanese Patent Application No. 2021-177857, filed on Oct. 29, 2021, the entire contents of which are incorporated herein by reference.

### BACKGROUND

The present invention relates to an antenna device.

Electronic component modules to be installed in electronic equipment have been downsized with miniaturization of the electronic equipment. For example, JP 2009-111287A listed below discloses a circuit board including an insulating layer of glass epoxy resin and wiring comprising a metal thin film of, for instance, copper foil, formed on surfaces of the insulating layer.

Microstrip antennas having been attracting attention as antennas that are easily formable on such a circuit board. The microstrip antenna is an antenna including a parallel plate resonator constituted by a radiating element formed on a surface of a substrate and a ground plane formed on the other surface of the substrate.

### SUMMARY

However, reducing usage amounts of conductive materials such as metal for the circuit board has been considered due to recent increase in resource prices and raising of environmental awareness.

Accordingly, the present invention is made in view of the aforementioned issues, and an object of the present invention is to provide a novel and improved antenna device that makes it possible to reduce the usage amounts of conductive materials.

### SUMMARY OF INVENTION

### Technical Problem

To solve the above described problem, according to an aspect of the present invention, there is provided an antenna device comprising a flat dielectric substrate a radiating element disposed on a surface of the dielectric substrate and a ground plane disposed on another surface opposite to the surface of the dielectric substrate wherein the radiating element has a size corresponding to operating frequency of the radiating element, and the ground plane has a plurality of openings that are periodically made at a pitch less than ¼ wavelength of the operating frequency.

As described above, according to the present invention, it is possible to reduce the usage amounts of conductive materials.

### BRIEF DESCRIPTION OF THE DRAWINGS

FIG. 1 is a perspective view of a configuration of an antenna device according to a first embodiment of the present invention.

FIG. 2 is a vertical cross-sectional view of the configuration of the antenna device according to the embodiment.

FIG. 3 is a plan view of an example of a shape and arrangement pattern of openings made in a ground plane.

FIG. 4 is an enlarged plan view of a partial area illustrated in FIG. 3.

FIG. 5 is a plan view of another example of the shape and arrangement pattern of openings made in the ground plane.

FIG. 6 is a vertical cross-sectional view of a configuration of an antenna device according to a second embodiment of the present invention.

FIG. 7 is a vertical cross-sectional view of a configuration of an antenna device according to a third embodiment of the present invention.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

<1. First Embodiment>

(1.1 Antenna Device)

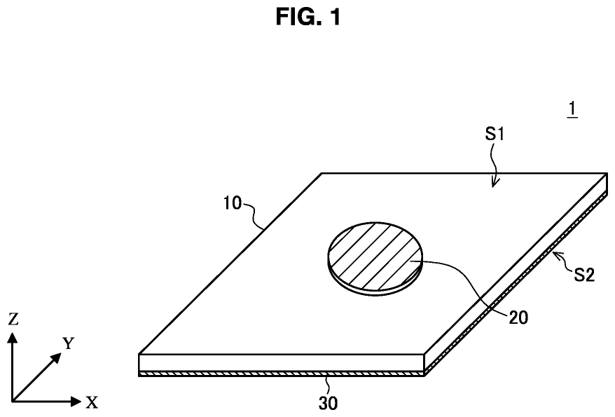

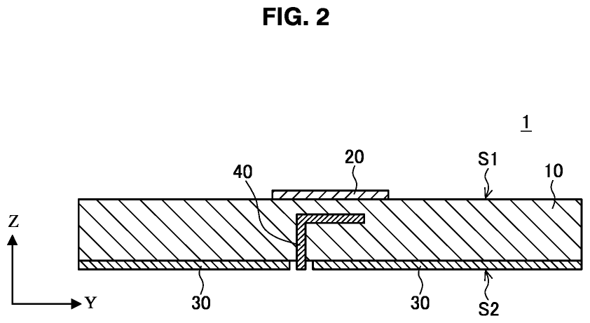

First, a configuration example of an antenna device according to a first embodiment of the present invention will be described with reference to FIG. 1 and FIG. 2. FIG. 1 is a perspective view of a configuration of an antenna device 1 according to the first embodiment of the present invention. FIG. 2 is a vertical cross-sectional view of the configuration of the antenna device 1 according to the first embodiment of the present invention.

As illustrated in FIG. 1 and FIG. 2, the antenna device 1 according to the present embodiment includes a dielectric substrate 10, a radiating element 20, a ground plane 30, and a feed probe 40. The antenna device 1 according to the present embodiment is a so-called microstrip antenna formed on the dielectric substrate 10.

The dielectric substrate 10 is a flat substrate including dielectric material. As an example, the dielectric substrate 10 may be a printed circuit board such as a paper phenol board, a paper epoxy board, or a glass epoxy board obtained by impregnating paper, glass fiber cloth, or the like with organic resin or the like. As another example, the dielectric substrate 10 may be a ceramic substrate including aluminium oxides.

The radiating element 20 includes conductive material and is disposed on a first surface S1 of the dielectric substrate 10. The radiating element 20 has a circular or rectangular open boundary, and functions as an antenna capable of radiating or absorbing electromagnetic waves. For example, the radiating element 20 may include metal foil such as copper foil attached to the first surface S1 of the dielectric substrate 10. In addition, the radiating element 20 has a size capable of having desired properties in a desired operating frequency band. Specifically, the radiating element 20 may have a planar shape and has a size corresponding to the desired operating frequency (for example, approximately ½ wavelength). However, the radiating element 20 may have the planar shape but have a size smaller than the ½ wavelength of the desired operating frequency by using a publicly known technology of downsizing the radiating element 20 as long as the radiating element 20 has the desired properties.

For example, the radiating element 20 may have a circular shape having a diameter which is approximately ½ wavelength of the operating frequency, an oval shape having a major axis which is approximately ½ wavelength of the operating frequency, or a rectangular shape having a side length which is approximately 1/2 wavelength of the operating frequency. In addition, the radiating element 20 may have one of these shapes with slits or a notches.

The ground plane 30 includes conductive material and is disposed on a second surface S2, which is opposite to the first surface Si of the dielectric substrate 10. The ground plane 30 constitutes a parallel plate resonator between the ground plane 30 and the radiating element 20, and this causes the radiating element 20 to function as an antenna. Specifically, when the ground plane 30 is supplied with a ground potential and the radiating element 20 is supplied with electric power in a high-frequency band, the radiating element 20 and the ground plane 30 resonate at a frequency in such a manner that the size of the planar shape of the radiating element 20 corresponds to ½ wavelength. At this time, an electric field is generated at the edge of the radiating element 20, and a portion of an electromagnetic field generated from a magnetic current source and equivalent to the electric field is radiated into a space as electromagnetic waves. This allows the antenna device 1 to radiate the electromagnetic waves in such a manner that the size of the planar shape of the radiating element 20 corresponds to ½ wavelength.

Note that, the ground plane 30 is disposed at least in an area corresponding to an area including the radiating element 20. In other words, the ground plane 30 is disposed at least in a projection area obtained by projecting the area including the radiating element 20 onto the second surface S2. For example, the ground plane 30 may include metal foil such as copper foil attached to the second surface S2 of the dielectric substrate 10.

The radiating element 20 and the ground plane 30 may be formed by using same metal foil. In this case, the radiating element 20 and the ground plane 30 include same conductive material and have a same thickness. In this case, it is possible to further simplify the process of manufacturing the antenna device 1.

The feed probe 40 is disposed on the second surface S2 of the dielectric substrate 10 and extends into an inside of the dielectric substrate 10. Specifically, the feed probe 40 is disposed in the projection area on the second surface S2, extends into the inside of the dielectric substrate 10, and is bent in such a manner that the bent feed probe 40 becomes parallel to the radiating element 20. The projection area is on the opposite side to the area including the radiating element 20. The feed probe 40 is capable of supplying electric power in a high-frequency band to the radiating element 20 through capacitive coupling between the feed probe 40 and the radiating element 20. The feed probe 40 may include conductive material. The conductive material include metal such as copper, aluminium, titanium, or tungsten.

Since the ground plane 30 constitutes the parallel plate resonator, the ground plane 30 occupies a wider area (for example, the whole second surface S2 of the dielectric substrate 10) than the area including the radiating element 20. Therefore, more conductive material is attached to the second surface S2 than the first surface 51 of the dielectric substrate 10. The ground plane 30 of the antenna device 1 according to the present embodiment has a plurality of openings that are periodically made at a pitch less than ¼ wavelength of the operating frequency of the radiating element 20. By making the periodic openings in the ground plane 30, it is possible to reduce the usage amount of conductive material included in the ground plane 30 of the antenna device 1 according to the present embodiment without reducing the area including the ground plane 30.

The periodic openings made in the ground plane 30 also makes it possible to reduce a difference between the usage amount of conductive material included in the ground plane 30 and the usage amount of conductive material included in the radiating element 20 of the antenna device 1 according to the present embodiment. This makes it possible to suppress warpage of the dielectric substrate 10 of the antenna device 1 according to the present embodiment when temperature changes.

Specifically, when the temperature changes, stress is generated in the dielectric substrate 10 by a difference in thermal expansion rate between the dielectric material included in the dielectric substrate 10 and the conductive material included in the ground plane 30. At this time, the dielectric substrate 10 may warp due to increase in a difference between stress generated in the first surface 51 and stress generated in the second surface S2 in the case where there is a large difference between the usage amount of the conductive material included in the ground plane 30 and the usage amount of the conductive material included in the radiating element 20. When using the antenna device 1 according to the present embodiment, it is possible to reduce the difference in usage amount between conductive material of the first surface 51 and conductive material of the second surface S2. Therefore, it is possible to suppress the warpage of the dielectric substrate 10.

(1.2. Ground Plane)

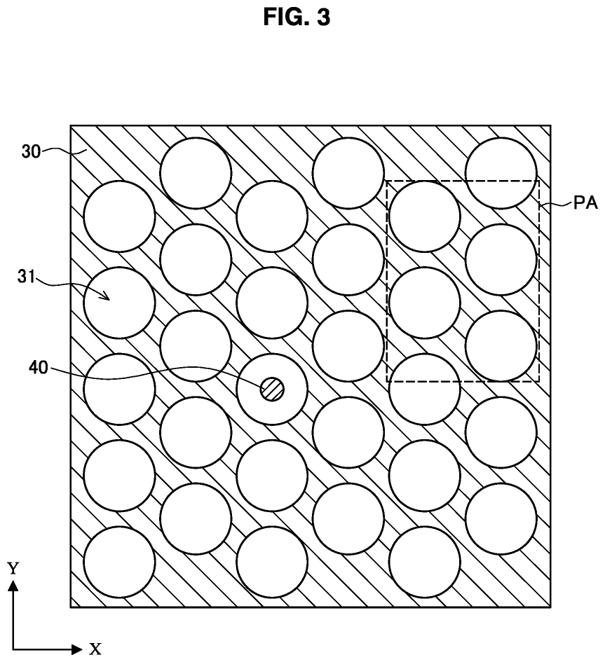

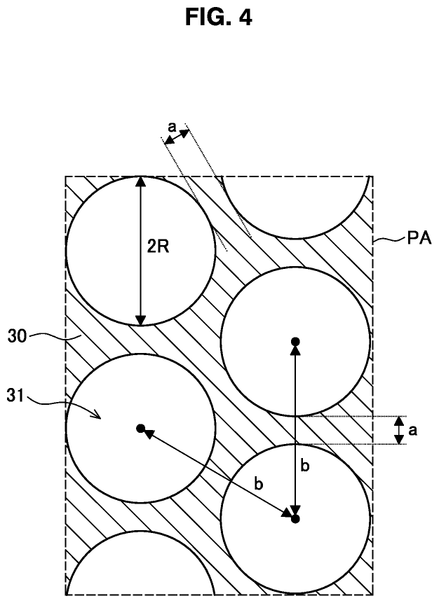

Next, with reference to FIG. 3 and FIG. 4, a shape and arrangement pattern of openings made in the ground plane 30 of the antenna device 1 according to the present embodiment will be described. FIG. 3 is a plan view of an example of the shape and arrangement pattern of the openings made in the ground plane 30. FIG. 4 is an enlarged plan view of a partial area PA illustrated in FIG. 3.

As illustrated in FIG. 3, for example, the ground plane 30 may have a plurality of periodic openings 31, and the ground plane 30 may be disposed on the whole second surface S2 of the dielectric substrate 10. For example, the openings 31 may have a circular planar shape and may be periodically made at positions corresponding to respective vertices of an equilateral triangle (in other words, equilateral triangular lattice).

To further improve antenna characteristics of the antenna device 1, the ground plane 30 is desirably disposed on the whole second surface S2 of the dielectric substrate 10. However, in this case, the usage amount of conductive material included in the ground plane 30 drastically increases. By making the periodic openings 31 in the ground plane 30, it is possible to dispose the ground plane 30 on the whole second surface S2 of the antenna device 1 according to the present embodiment and reduce the usage amount of the conductive material.

Specifically, as indicated by the partial area PA illustrated in FIG. 4, the openings 31 have the circular planar shape and are periodically arrayed at a pitch b, which is less than ¼ wavelength of the operating frequency of the radiating element 20. The pitch b of the openings 31 is a distance between centers of the circular openings 31. An interval a between the openings 31 made in the ground plane 30 is a distance obtained by subtracting a diameter 2R of the opening 31 from the pitch b.

The openings 31 may be made in such a manner that the interval a between the openings 31 made in the ground plane 30 is minimized as long as acceptable manufacturing cost and acceptable strength are maintained. In this case, it is possible to suppress effects on the antenna characteristics and further reduce the usage amounts of the conductive materials by further reducing the interval a between the openings 31 made on the remaining ground plane 30.

Since the openings 31 are arrayed as described above, it is possible to prevent the intervals a on the remaining ground plane 30 from having a size of ¼ wavelength or more of the operating frequency of the radiating element 20 of the antenna device 1. For example, in the case where the interval a on the remaining ground plane 30 has the size of ¼ wavelength or more of the operating frequency of the radiating element 20, a plurality of reflection points are formed on the ground plane 30, an unintended resonator is formed, and the resonator makes a standing wave. In this case, the standing wave made by the unintended resonator deteriorates the antenna characteristics of the antenna device 1. The antenna device 1 according to the present embodiment makes it possible to prevent formation of the unintended resonator. This makes it possible to prevent the deterioration in antenna characteristics.

In addition, by arraying the openings 31 as described above, it is possible to prevent the remaining ground plane 30 from having a complicated geometric pattern.

For example, in the case where the remaining ground plane 30 has the complicated geometric pattern (such as a meander pattern or an interdigitated pattern), inductance and capacitance are unintentionally applied to the ground plane 30. This may deteriorate the antenna characteristics of the antenna device 1. The antenna device 1 according to the present embodiment makes it possible to prevent the unintended inductance and capacitance. This makes it possible to prevent the deterioration in antenna characteristics.

Note that, it is also possible to change the arrangement of the openings 31 as long as the antenna characteristics of the antenna device 1 do not deteriorate. For example, in the case where some intervals a on the remaining ground plane 30 have the size of ¼ wavelength or more of the operating frequency of the radiating element 20, this may affect the antenna characteristics of the antenna device 1. Accordingly, the openings 31 may deviate from the periodic array as long as the some intervals a on the remaining ground plane 30 have the size less than ¼ wavelength of the operating frequency of the radiating element 20. In other words, the openings 31 do not have to be arrayed in a completely periodic manner, but may be arrayed in a partially deviated manner or other manners.

For example, the feed probe 40 is electrically separated from the ground plane 30. Therefore, it is also possible to dispose the feed probe 40 in the opening 31. In this case, the openings 31 may be made at positions deviated from the respective vertices of the equilateral triangle, the positions corresponding to the positions of the feed probes 40.

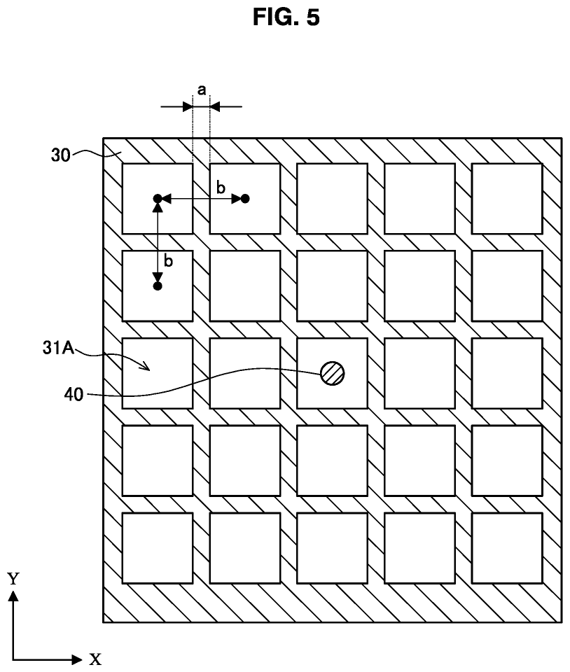

FIG. 3 and FIG. 4 illustrate the example of arraying the openings 31 having the circular planar shape at positions corresponding to the respective vertices of the equilateral triangle. However, the present embodiment is not limited thereto. For example, as illustrated in FIG. 5, openings 31A may have a rectangular planar shape and may be made at positions corresponding to respective vertices of a square (in other words, square lattice). FIG. 5 is a plan view of another example of a shape and arrangement pattern of the openings 31A made in the ground plane 30.

Specifically, the openings 31A has a rectangular planar shape and are arrayed at a pitch b, which is less than ¼ wavelength of the operating frequency of the radiating element 20, in a vertical direction (Y axis direction) and in a horizontal direction (X axis direction). The pitch b of the openings 31A is a distance between centroids of the rectangular openings 31A. An interval a between the openings 31A made in the ground plane 30 is a distance obtained by subtracting the length of a side of the opening 31 from the pitch b. The openings 31A may be made in such a manner that the interval a between the openings 31A made in the ground plane 30 is minimized as long as acceptable manufacturing cost and acceptable strength are maintained. In this case, it is possible to suppress effects on the antenna characteristics and reduce the usage amounts of the conductive materials by further reducing the interval a between the openings 31 made on the remaining ground plane 30.

Instead of the circular planar shape or the rectangular planar shape, the openings 31 may have an oval planar shape, a polygonal planar shape, or other planar shapes. However, in view of ease of making the openings 31 in the ground plane 30, the openings 31 preferably has the circular planar shape or the oval planar shape with no corner. In addition, to further increase the number of openings 31 made in the ground plane 30 and to further reduce the usage amounts of the conductive materials, the openings 31 are preferably arrayed in such a manner that the openings 31 correspond to respective vertices of an equilateral triangle having a high tessellation level.

(1.3. Embodiments)

An embodiment of the antenna device 1 will be described on the basis of the array of the openings 31 illustrated in FIG. 3.and FIG. 4. Note that, the size of the openings 31 and the like of the antenna device 1 according to the present embodiment is not limited to examples to be described below.

For example, the radiating element 20 has a size of about 7 mm in the case where the radiating element 20 having the operating frequency 10 GHz is disposed on the dielectric substrate 10 having relative permittivity of 4.8 and having a size of 40 mm×40 mm. In addition, a pad connected to the feed probe 40 has a diameter of 1 mm, and a distance between the pad and the ground plane 30 is 0.5 mm.

In the case where no opening 31 is made in the ground plane 30, a ratio of the area of the radiating element 20 to the area of the first surface S1 is 2.41% of the area of the whole first surface S1. In addition, a ratio of the area of the ground plane 30 to the area of the second surface S2 is 99.85% of the area of the whole second surface S2.

However, a ratio of the area of the ground plane 30 to the area of the second surface S2 is 19.38% of the area of the whole second surface S2 in the case where the openings 31 are made in the ground plane 30, the pitch b of the openings 31 is 3.5 mm, the circular openings 31 has the diameter 2R of 3.3 mm, and the intervals a on the ground plane 30 is 0.2 mm.

This makes it possible to drastically reduce the usage amount of conductive material included in the ground plane 30 of the antenna device 1 according to the present embodiment from 99.85% to 19.38%. In addition, it is possible to reduce the difference between the ratio of the area of the radiating element 20 to the first surface Si and the ratio of the area of the ground plane 30 to the second surface S2 of the antenna device 1 according to the present embodiment. This makes it possible to reduce a difference between stress generated in the first surface Si and stress generated in the second surface S2, and suppress the warpage of the dielectric substrate 10 of the antenna device 1 according to the present embodiment.

<2. Second Embodiment>

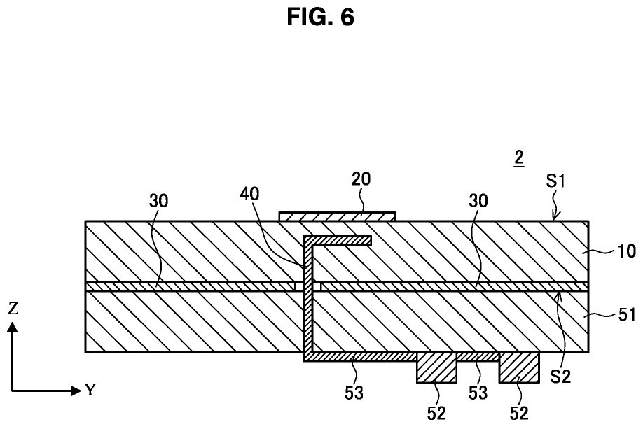

Next, an antenna device 2 according to a second embodiment of the present invention will be described with reference to FIG. 6. FIG. 6 is a vertical cross-sectional view of the configuration of the antenna device 2 according to the second embodiment of the present invention.

As illustrated in FIG. 6, the antenna device 2 according to the present embodiment includes the dielectric substrate 10, the radiating element 20, the ground plane 30, the feed probe 40, a wiring substrate 51, electronic components 52, and wiring 53. The antenna device 2 is different from the first embodiment in that the wiring substrate 51 on which the electronic components 52 are disposed is stacked on the second surface S2 of the dielectric substrate 10 on which the radiating element 20 and the ground plane 30 are disposed. The dielectric substrate 10, the radiating element 20, the ground plane 30, and the feed probe 40 are substantially similar to the first embodiment. Therefore, repeated description thereof will be omitted here.

The wiring substrate 51 is a printed circuit board such as a paper phenol board, a paper epoxy board, or a glass epoxy board. The electronic component 52 may be an integrated circuit, a resistor, a capacitor, or the like. For example, the electronic components 52 are disposed on a surface opposite to a surface through which the wiring substrate 51 are stacked on the dielectric substrate 10. The electronic components 52 are electrically connected to each other via the wiring 53. In addition, the feed probe 40 disposed in the dielectric substrate 10 penetrates the wiring substrate 51, extends to the surface on which the electronic components 52 are disposed, and are electrically connected to the electronic components 52 via the wiring 53. The electronic components 52 controls supply of electric power to the radiating element 20.

In the antenna device 1 according to the present embodiment, the electronic components 52 and the wiring 53 are disposed near the radiating element 20. Therefore, electromagnetic waves radiated from the radiating element 20 may affect the electronic components 52 and the wiring 53. In this case, it is possible to protect the electronic components 52 and the wiring 53 from the electromagnetic waves radiated from the radiating element 20 when the ground plane 30 disposed between the radiating element 20 and a group of the wiring 53 and the electronic components 52 has an effect of blocking the electromagnetic waves (so-called electromagnetic-wave shielding effect).

Specifically, it is possible for the ground plane 30 to have the electromagnetic-wave shielding effect when the pitch of the periodic openings 31 made in the ground plane 30 is 1/10 wavelength or less of the operating frequency of the radiating element 20. The openings 31 made at the above-described pitch is sufficiently smaller than the wavelength of the electromagnetic waves radiated from the radiating element 20. Therefore, the openings 31 do not transmit the electromagnetic waves radiated from the radiating element 20, and the electromagnetic waves are blocked by the ground plane 30. This allows the antenna device 2 according to the present embodiment to suppress effects of the electromagnetic waves on the electronic components 52 and the wiring 53, by using the ground plane 30 to block the electromagnetic waves radiated from the radiating element 20.

<3. Third Embodiment>

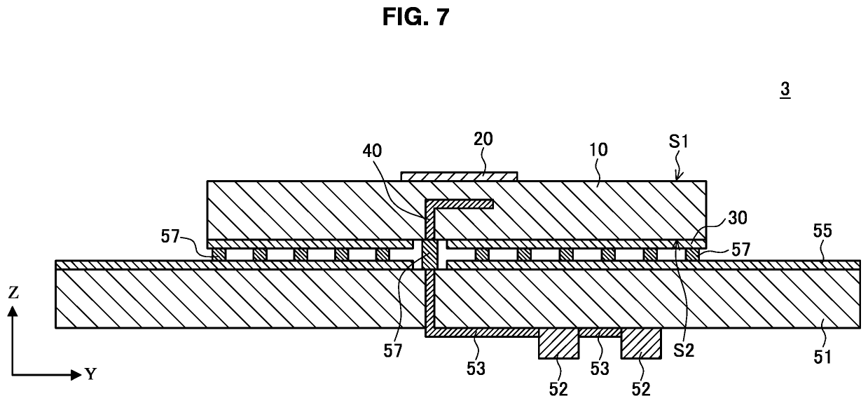

Next, an antenna device 3 according to a third embodiment of the present invention will be described with reference to FIG. 7. FIG. 7 is a vertical cross-sectional view of the configuration of the antenna device 3 according to the third embodiment of the present invention.

As illustrated in FIG. 7, the antenna device 3 according to the present embodiment includes the dielectric substrate 10, the radiating element 20, the ground plane 30, the feed probe 40, the wiring substrate 51, the electronic components 52, the wiring 53, a substrate-side ground plane 55, and junctions 57.

The antenna device 3 is different from the first embodiment in that the wiring substrate 51 is stacked below the second surface S2 of the dielectric substrate 10 on which the radiating element 20 and the ground plane 30 are disposed, and the ground plane 30 of the dielectric substrate 10 is electrically connected to the substrate-side ground plane 55 of the wiring substrate 51 via the junctions 57. The dielectric substrate 10, the radiating element 20, the ground plane 30, and the feed probe 40 are substantially similar to the first embodiment. Therefore, repeated description thereof will be omitted here. In addition, the wiring substrate 51, the electronic components 52, and the wiring 53 are substantially similar to the second embodiment. Therefore, repeated description thereof will be omitted here.

The substrate-side ground plane 55 is electrically separated from a junction 57 that is electrically connected to the feed probe 40. The substrate-side ground plane 55 is disposed on a whole surface of the wiring substrate 51, the surface being opposed to the dielectric substrate 10. For example, the substrate-side ground plane 55 may be uniformly disposed in an area other than an area around the junction 57 that is electrically connected to the feed probe 40. The substrate-side ground plane 55 is electrically connected to the ground plane 30 of the dielectric substrate 10 via junctions 57. The substrate-side ground plane 55 functions as a reference potential supply source of the wiring substrate 51 when the ground potential is supplied.

The junctions 57 is an inter-substrate connection structures including solder joints. The junctions 57 connect the ground plane 30 to the substrate-side ground plane 55 electrically and physically. For example, the junction 57 may be a connection structure including a bump formed on the ground plane 30, a bump formed on the substrate-side ground plane 55, and a solder ball sandwiched between these bumps.

In the antenna device 3 according to the present embodiment, the ground plane 30 and the substrate-side ground plane 55 are electrically and physically connected via the junctions 57. Therefore, for preventing the openings 31 from being made at positions corresponding to the junctions 57 in the ground plane 30, it is also possible to change the arrangement of the openings 31 as long as the antenna characteristics of the antenna device 3 do not deteriorate. Specifically, the openings 31 made in the ground plane 30 may deviate from the periodic array in such a manner that the openings 31 deviate from the positions of the junctions 57. This makes it possible to connect the ground plane 30 to the substrate-side ground plane 55 of the antenna device 3 according to the present embodiment while the junctions 57 are arranged more flexibility.

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

For example, the planar shape of the radiating element 20 is not specifically limited. The radiating element 20 may have a square planar shape, a rectangular planar shape, a polygonal planar shape, a circular planar shape, an oval planar shape, or an interdigitated planar shape. In addition, the radiating element 20 may have one of these planar shapes with slits or notches.

For example, in the above-described embodiments, the single radiating element 20 is disposed on the first surface Si of the dielectric substrate 10. However, the present invention is not limited thereto. For example, a plurality of the radiating elements 20 may be disposed on the first surface Si of the dielectric substrate 10, and the plurality of radiating elements 20 may constitute an antenna array.

What is claimed is:

1. An antenna device comprising:
a flat dielectric substrate;
a radiating element disposed on a surface of the dielectric substrate; and
a ground plane disposed on another surface opposite to the surface of the dielectric substrate;
wherein the radiating element has a size corresponding to operating frequency of the radiating element, and the ground plane has a plurality of openings that are periodically made at a pitch less than ¼ wavelength of the operating frequency.

2. The antenna device according to claim 1,
wherein the openings have a circular shape or an oval shape.

3. The antenna device according to claim 1,
wherein the openings are made at positions corresponding to respective vertices of an equilateral triangle.

4. The antenna device according to claim 1,
wherein the ground plane is disposed at least in an area corresponding to an area including the radiating element.

5. The antenna device according to claim 4,
wherein the ground plane is disposed all over the other surface.

6. The antenna device according to claim 1,
wherein the radiating element has a rectangular shape, a circular shape, an oval shape, or one of these shapes with a slit or a notch.

7. The antenna device according to claim 1,
wherein the openings are periodically made at a pitch of 1/10 wavelength or less of the operating frequency.

8. The antenna device according to claim 1, further comprising
a feed probe configured to supply electric power to the radiating element through capacitive coupling, the feed probe being disposed on the other surface corresponding to the area including the radiating element and extending into an inside of the dielectric substrate.

9. The antenna device according to claim 1,
wherein the radiating element and the ground plane include a same conductive material and have a same thickness.
